(19) United States
(12) Patent Application Publication
(10) Pub. No.: US 2004/0204809 A1
(43) Pub. Date: Oct. 14, 2004

(54) Control device

(76) Inventor: Knut Balzer, Beilstein (DE)

Correspondence Address: KENYON & KENYON, ONE BROADWAY, NEW YORK, NY, 10004, US

(21) Appl. No.: 10/788,139

(22) Filed: Feb. 25, 2004

(30) Foreign Application Priority Data
Feb. 25, 2003 (DE) 10307878.9

(51) Int. Cl. G06F 17/00

(52) U.S. Cl. 701/45; 280/801.1

(57) ABSTRACT

A control device stores a value as a function of a signal from a belt-latch sensor and a usage of a vehicle and transmits this first value via an interface as a function of call-up signals.

### BACKGROUND INFORMATION

From German Patent Application No. DE 101 54 005, a secondary safety belt warning device is known which alerts a passenger who is not strapped in while seated in the vehicle seat, thereby reminding him to remedy this situation.

However, it is disadvantageous in this warning device that many people do not respond to this alert in the intended manner.

### SUMMARY OF THE INVENTION

The control device according to the present invention has the advantage over the related art that a first value is thereupon stored, namely as a function of a signal from a belt-latch sensor and a use of the vehicle. This allows a sum to be formed of the time during which a particular vehicle occupant is wearing a seatbelt. This sum is then made accessible to external sampling devices, in the form of a first value, thus making it possible to reward a vehicle occupant, and specifically the vehicle owner, for strapped-in passengers. After an accident in which airbags were triggered, this might result in more favorable terms for a repair of the airbag devices. Additional rewards might consist of more favorable terms being offered in connection with a vehicle inspection or the purchase of a new vehicle, based on the mileage driven with occupants wearing seatbelts. It is also possible that automotive insurers would offer more favorable conditions in connection with insurance premiums based on this sum, even if it is only in the form of a one-time grant, for example. The state may also offer better terms for the vehicle tax as a function of a desired driver behavior, which are likewise granted in the form of a one-time bonus, for example. The value may either be called up by means of a retrieval signal, or it may be read out directly from a memory.

It is particularly advantageous that the control device determines the use of the vehicle by the activation of an operating switch. During activation of the operating switch, that is, the vehicle switch, the control device may concurrently run a counter and sum it up to the first value if the particular belt latch is closed. If several people occupy the vehicle, the first value is increased accordingly, provided these passengers are strapped in as well. This then also has the advantage that good utilization of the vehicle, namely transporting several people, is rewarded in addition. As an alternative, it is possible that an operating counter, already present in the vehicle, is used to determine usage. The operating counter could be a timing element, for example, i.e., a chronometer, or also a speedometer, in order to ascertain the driven miles or distances. Therefore, either the time or the traveled kilometers or miles is/are measured in order to be summed up to the value, provided the particular occupants are hooked up. In the process, it may happen that an occupant detection detects more than one person in the vehicle and not all persons are strapped in. In such a case this value will not be increased, notwithstanding the fact that some of the passengers are wearing a safety belt. This, too, has a corresponding educational effect. Finally, it is also possible to add up the number of rides that were taken while passengers were wearing a seatbelt.

The interface via which this value may be queried from the outside is advantageously able to be connected to a plug connector of an external device so as to establish a wire-bound connection, or a connection to a transmitter-receiver station for a wireless transmission. The wireless transmission could be realized via infrared or via radio signals, for example, or also by means of a mobile radio device located in the vehicle, either permanently installed or plugged into a corresponding receptacle.

### BRIEF DESCRIPTION OF THE DRAWINGS

FIG. 1 shows a block diagram of the device according to the present invention, the device being connected to a plurality of units.

FIG. 2 shows a flow chart of the method running on the control device according to the present invention.

### DETAILED DESCRIPTION

Passenger-protection systems evolve on an ongoing basis in order to improve their protective effect and to reduce the number of annual traffic fatalities. For example, each year approximately 40,000 people are killed in traffic accidents in the United States. One of the quantitatively measurable goals of authorities such as the NHTSA (National Highway Traffic Safety Administration) is a reduction of this number by a specific percentage within a specified period of time. A clear improvement in the situation could be attained if, for example, the belt usage rate of passengers were able to be improved. At present, only 75% of U.S. passengers wear safety belts. There is no law in the U.S. that requires the use of safety belts. With the aid of so-called belt-minder systems that are already standard equipment in some vehicles, passengers are alerted at the beginning of the ride that the protective effect of the belt system is missing. Such systems have a negligible effect on passenger behavior, or on the correction of the behavior. Therefore, the objective is to induce passengers to buckle up voluntarily, without forcing them.

As stated, there is currently a lack of motivation for wearing safety belts, especially in the U.S. However, every increase in the percentage of the belt usage rate saves human lives in the three-digit range each year. There are other areas in daily life where consumer behavior is influenced successfully. One example is the deposit for shopping carts, which results in the user returning the shopping cart to the original location. Another example are rebate systems such as accumulating airplane mileage, which have the result that users remain loyal to a particular airline company. According to the present invention, a control device is therefore provided which measures only the time or the distance traveled during which a particular vehicle occupant is wearing a seatbelt. That means that the time or the distance is added up during which the occupants are strapped in. This has the advantage that the passenger is rewarded for his or her conduct and the general public saves money that would have to be spent for health-related care and possibly the care for surviving dependents. Passengers receive an incentive in that they are rewarded as a function of the accumulated seat-belt usage, either by the vehicle manufacturer, the insurer or the state. Service facilities may also become part of this reward system.

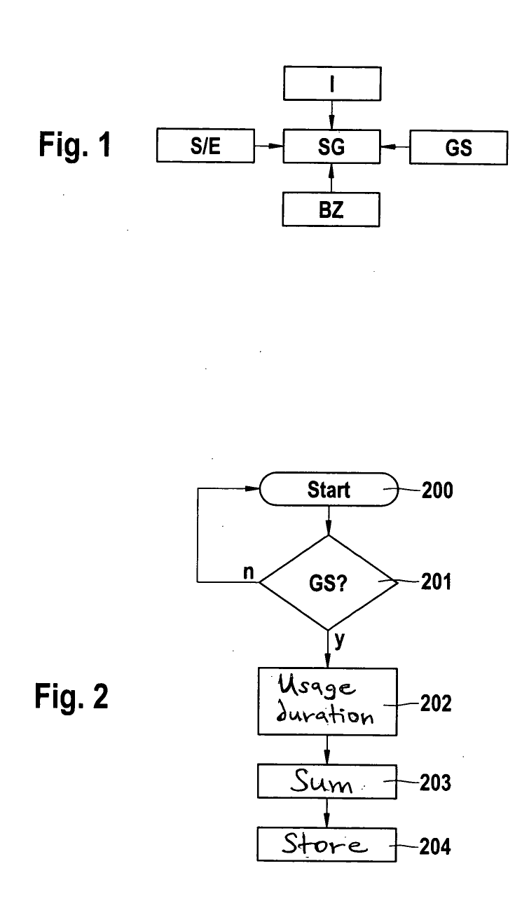

FIG. 1 shows, in the form of a block diagram, how control device SG according to the present invention is connected to other components of a vehicle in order to achieve this objective. Via a first data input, control device SG is connected to a belt-latch sensor GS. Only one belt-latch sensor GS is shown here by way of example, but a plurality of belt-latch sensors will be connectable to control device SG. Control device SG receives from belt-latch sensor GS the signal whether or not the belt latch is closed, that is, whether or not the passenger is strapped in. Via a second data input, control device SG is connected to an operating counter BZ. Operating counter BZ informs control device SG whether the vehicle has been taken into operation. For this purpose, either a signal from an operating switch, such as a vehicle lock, may be utilized or also an already installed operating-time counter or a speedometer. Via a third data input, control device SG is connected to an occupant detection I. This occupant detection I recognizes whether or not an individual passenger is present in the vehicle. Vehicle-occupant detection I may be designed as weight-based occupant detection or also as image-generating occupant detection, for example in the form of a video detection, ultrasound detection or radar detection. In this way, control device SG ascertains whether persons are present in the vehicle, and via the signals from belt-latch sensors GS it detects whether the individual passengers are wearing seatbelts. Operating counter BZ provides control device SG with the information whether the vehicle has been taken into operation. As an alternative, it is possible that control device SG is not connected to an operating counter BZ and, solely from its own operation, already detects that the vehicle has been put into operation. Control device SG is connected to a transmitter-receiver station SE via a data output. Transmitter-receiver station SE is provided to make the value summed up as usage by control device SG in response to seatbelts being worn accessible to external query options. Such options may be realized, for example, in a service facility via an appropriate test plug, or also via an infrared interface or via a radio interface, such as mobile radio communication. In addition, it is possible that this value is transmitted to a central memory device via a permanently set transmitter-receiver station, such as a mobile telephone, so that these belt-usage times or also the belt-usage miles are centrally administered in order to protect them from manipulation.

Control device SG must then transmit an appropriate vehicle identification or driver identification as well so that the value may be stored in the central memory device in an appropriate manner. This connection may also be realized over the Internet, for example. Furthermore, it may be provided that control device SG already refrains from adding up any value when a passenger, seated in the vehicle and detected by occupant detection I, does not use a seatbelt, so that the vehicle driver is punished for transporting persons who fail to wear a seatbelt. As an alternative, it is possible that occupant detection I is not present and only the signal from belt-latch sensor GS is utilized.

The flow chart in FIG. 2 visualizes the sequence through which control device SG runs. The method begins in method step 200. In method step 201, it is checked on the basis of a signal from belt-latch sensor GS whether a person is strapped in. If appropriate, signals from occupant detection I are taken into consideration as well. However, if it is detected in method step 201 that no seatbelts are worn, it is returned to method step 200 since there is no need now to increase a value. However, if it has been detected that seatbelts are worn, it is skipped to method step 202 and the value is added up in method step 203 during the usage duration of the vehicle and the seatbelt usage. In the process, either the time during which a seatbelt was worn is added up or the driven kilometers or the driven distance during which the seatbelts were fastened. This value is then stored in control device SG in method step 204. If an external query requests the output of this value, such an output is implemented via interface SE. As shown above, it may alternatively be provided that this value is continually transmitted to a center at certain time intervals in order to be accumulated there.

What is claimed is:

1. A control device for a vehicle, the vehicle having a belt-latch sensor, the control device comprising:
an arrangement for storing at least one first value as a function of a signal from the belt-latch sensor and a usage of the vehicle, and for transmitting the at least one first value via an interface in response to the at least one first value being called up.

2. The control device according to claim 1, wherein the control device is connectable to an operating switch of the vehicle in such a way that the control device determines the usage of the vehicle by an activation of the operating switch.

3. The control device according to claim 1, wherein the control device is connectable to an operating counter of the vehicle in such a way that the control device determines the usage of the vehicle by a second value of the operating counter.

4. The control device according to claim 3, wherein the operating counter is a timing element.

5. The control device according to claim 3, wherein the operating counter is a speedometer.

6. The control device according to claim 1, wherein the interface is connectable to a plug connector of an external device.

7. The control device according to claim 1, wherein the interface is connectable to a transmitter-receiver station for a wireless transmission of the first value.

8. The control device according to claim 1, wherein the arrangement generates the first value by adding up a duration of the vehicle usage during which a belt latch of the vehicle is locked.

9. The control device according to claim 1, wherein the control device is connectable to an occupant detection.
